(19) United States
(12) Patent Application Publication
(10) Pub. No.: US 2004/0057465 A1
(43) Pub. Date: Mar. 25, 2004

(54) Flexible data partitioning and packetization for H.26L for improved packet loss resilience

(75) Inventors: Yingwel Chen, Briarcliff Manor, NY (US); Jong Chul Ye, Croton-on-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/253,234

(22) Filed: Sep. 24, 2002

(51) Int. Cl. H04J 3/22

(52) U.S. Cl. 370/474

(57) ABSTRACT

A method and system of partitioning and packetizing video data in an H.26L environment. An H.26L coding system is disclosed, comprising: a video coding layer (VCL) having a first partition mode and a second partition mode for partitioning video data, wherein the second partition mode separately partitions low and high frequency DCT coefficients; and a network adaptation layer (NAL) for packetizing data into a first and second packet, wherein the first packet is configured to contain all low frequency DCT coefficients and the second packet is configured to contain all high frequency DCT coefficients when the second partition mode is implemented by the VCL.

### BACKGROUND OF THE INVENTION

1. Technical Field

The present invention relates generally to data packetization, and more specifically to a partitioning and packetization scheme for the transmission of coded video, improvements in the data partitioning syntax, and the corresponding network adaptation layer (NAL) packetization process to enable flexible data partitioning in an H.26L protocol environment.

2. Related Art

The emergence of WLAN technologies with high bandwidth capability from several mega bits per second to tens of mega bits per second is enabling high quality video streaming over such networks. Recently, 802.11b became a popular standard-based wireless Ethernet networking technology for both business and home. With a realistic payload throughput of 6 Mbps, it is fast enough for most network applications, including coded video broadcasts.

However, many challenges exist for transmitting high quality wireless video signals, mainly due to limitations relating to bandwidth constraints and high error rates. Because wireless networks may be highly susceptible to interferences from other devices operating in the same frequency band, packet errors or losses may often result. This is particularly the case in an 802.11b wireless LAN environment, which utilizes the 2.4GHz ISM band that is shared by microwaves, cordless phones and/or other 802.11b networks. Another challenge for transmitting video over an 802.11b networks is that the 802.11b media access (MAC) layer requires packets received with bit errors to be discarded, thereby limiting the possibility of error correction at the receiver.

However, the MAC layer and the application layer can provide unequal error protection (UEP) to certain packets to guarantee their on-time arrival. For example, at least 50% of all packets can be delivered virtually free of losses even under co-channel interference that degrades the channel throughput by 50%. The combination of scalable or layered coding and transmission with UEP can make sure that the essential parts of video get through even under channel disturbances while the non-essential parts get through only if the channel has enough throughput. For maximum benefits provided by data partitioning and UEP, a partition ratio of around 50% base vs. 50% enhancement may be desirable for optimal video quality if the enhancement layer packets are lost. An overly low partition ratio will result in under-utilization of the UEP capability of the underlying network.

Recently, the H.26L standard was introduced to achieve enhanced compression performance while providing a “network-friendly” video representation addressing “conversational” (video telephony) and “non-conversational” (storage, broadcast, or streaming) applications. The H.26L standard includes a Video Coding Layer (VCL), which provides the core high-compression representation of the video picture content, and a Network Adaptation Layer (NAL), which packages that representation for delivery over a particular type of network.

Unfortunately, the current data partitioning syntax in the H.26L video coding layer (VCL) provides little flexibility in selecting the partitioning ratio. Fixed partitioning does not fit well with the diverse unequal error protection capability provided by different networks, such as 802.11a and 802.11b. Fixed partitioning also disallows rate-distortion optimization of base layer video quality.

Current H.26L (or Joint Video Team, or JVT, or MPEG-4 Video Part 10) specifies a data partitioning syntax in the byte stream (video elementary stream) that allows three fixed partition types: Partition A that contains header symbols of coded macroblocks; Partion B that contains coded block patterns and DCT data for intra blocks; and Partition C that contains coded block patterns and DCT data for inter blocks. H.26L also specifies a packetization process in the Network Adaptation Layer (NAL) that packetizes the three partitions into three packets. The three packets have different transport (such as RTP, or Real Time Transport Protocol) payload types, which will signal to the application layer or the underlying network transport layer to provide differentiated service or unequal error protection. On the receiver side, the packets containing different partitions are depacketized and merged into a single bitstream (with multiple partitions) for decoding. While this system provides some level of resilience against packet losses, it has several drawbacks.

First, the fixed partitioning and NAL packetization process do not allow any rate-distortion optimization of the partitioning operation. This will result in lower video quality (when enhancement layer data are lost) compared with flexible data partitioning where the partitioning point and the corresponding base versus enhancement layer packet boundary can be changed adaptively based on picture statistics.

Second, the fixed partitioning and packetization limits the ratio of base and enhancement layers to a small range determined by the amount of header and motion vector information versus DCT data. Because the H.26L standard is designed for multiple applications, such as home cinema and video streaming, the application or the underlying network will have varying capabilities for unequal error protection. A fixed ratio for base and enhancement layer partitions will not allow optimization of the overall system performance where unequal error protection is available.

Accordingly, the need exists for improvements to provide more data partitioning flexibility within an H.26L environment, which is essential to supporting video communication applications over diverse packet-lossy networks.

### SUMMARY OF THE INVENTION

The invention addresses the above-mentioned problems, as well as others, by providing modifications to the VCL data partitioning syntax and the corresponding NAL packetization process to enable flexible data partitioning. In a first aspect, the invention provides an H.26L coding system, comprising: a video coding layer (VCL) having a first partition mode and a second partition mode for partitioning video data, wherein the second partition mode separately partitions low and high frequency DCT coefficients; and a network adaptation layer (NAL) for packetizing data into a first and second packet, wherein the first packet is configured to contain low frequency DCT coefficients and the second packet is configured to contain high frequency DCT coefficients when the second partition mode is implemented by the VCL.

In a second aspect, the invention provides a method of partitioning and packetizing video data in an H.26L environment, comprising: providing a video coding layer (VCL) having a first partition mode and a second partition mode for partitioning video data; partitioning video data into the three partitions (A, B and C) when the first partition mode is selected; and partitioning video data into a first partition (containing header information and lower frequency DCT data) and a second partition (higher frequency DCT data) when the second partition mode is selected.

In a third aspect, the invention provides a program product stored on a recordable medium for packetizing and partitioning video data in an H.26L environment, comprising: a video coding layer (VCL) having a first partition mode and a second partition mode for partitioning video data; means for partitioning video data into three partitions (A, B and C) when the first partition mode is selected; and means for partitioning video data into a first partition (containing header information and lower frequency DCT data) and a second partition (higher frequency DCT data) when the second partition mode is selected.

In a fourth aspect, the invention provides a decoding system for decoding video data in an H.26L environment, wherein the video data was packetized in one of two schemes, including: a first scheme, wherein header data is packetized into a first packet type, coded block pattern and DCT data for intra blocks are packetized into a second packet type, and coded block pattern and DCT data for inter blocks are packetized into a third packet type; a second scheme, wherein header data and low frequency DCT coefficients are packetized into the first packet type and high frequency DCT coefficients are packetized into the second packet type; and wherein the decoding system includes: a depacketizer system for determining which of the first and second scheme was used, and for depacketizing video data from the packets; and a decoder for decoding the video data.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an H.26L video transmission system in accordance with an embodiment of the present invention.

FIG. 2 depicts a packetization boundary indication (PBI) field in accordance with an embodiment of the present invention.

### DETAILED DESCRIPTION OF THE INVENTION

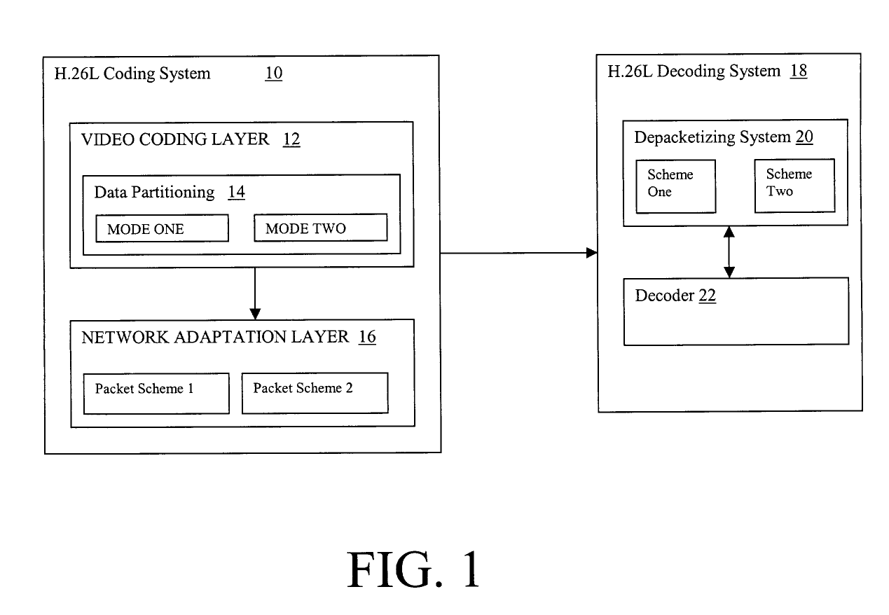

Referring to FIG. 1, a video transmission network is shown for transmitting a byte stream between an H.26L encoding system 10 and an H.26L decoding system. H.26L encoding system 10 includes a Video Coding Layer (VCL) 12 and a Network Adaptation Layer (NAL) 16. As is known in the art, the VCL 12 includes a unique syntax to efficiently represent the content of the video data, and the NAL 16 is defined to format that data and provide header information in a manner appropriate for conveyance by the higher-level system. The data is organized into data packets, each of which contains an integer number of bytes. These data packets are then transmitted in a manner defined by the NAL 16.

Data Partitioning re-arranges the symbols in a way that all symbols of one data type (e.g., DC coefficients, macroblock headers, motion vectors) that belong to a single slice are collected in one VLC coded bitstream that starts byte aligned. Decoder system 18 can process such a partitioned data streams by fetching symbols from the correct partition.

In accordance with the present invention VCL 12 includes a data partitioning system 14 that can partition based on one of two modes, i.e., Mode One and Mode Two. Mode One, which comprises header vs. DCT data, is syntactically defined by the existing H.26L specification, where there are eight syntax element types in the VCL as follows:

0—TYPE_HEADER

1—TYPE_MBHEADER

2—TYPE_MVD

3—TYPE_CBP

4—TYPE_{—}2×2DC

5—TYPE_COEFF_Y

6—TYPE_COEFF_{—C}

7—TYPE_EOS

Because partition Mode One remains unchanged from the existing H.26L specification, backward compatibility is maintained. Mode Two, which provides DCT partitioning, is added to provide enhanced partitioning flexibility. As discussed below, the NAL packetization scheme varies according to the partition mode used in the byte stream.

In partition Mode Two, i.e., DCT partitioning, TYPE-COEFF_Y and TYPE_COEFF_C are each further divided into two new partitions that represent high and low frequency DCT coefficients. Namely, TYPE-COEFF_Y has been broken into TYPE_COEFF_Y_L and TYPE_COEFF_Y_H; and TYPE_COEFF_C has been broken into TYPE_{—COEFF}_C_L, and TYPE_COEFF_C_H. It should be understood that the selection of a naming convention for these new types could change without departing from the scope of the invention. Accordingly, for Mode Two, the data partitioning system provides 10 syntax element types as follows:

0—TYPE_HEADER

1—TYPE_MBHEADER

2—TYPE_MVD

3—TYPE_CBP

4—TYPE_{—}2×2DC

5—TYPE_COEFF_Y_L

6—TYPE_COEFF_C_L

7—TYPE_COEFF_Y_H

8—TYPE_COEFF_C_H

9—TYPE_EOS

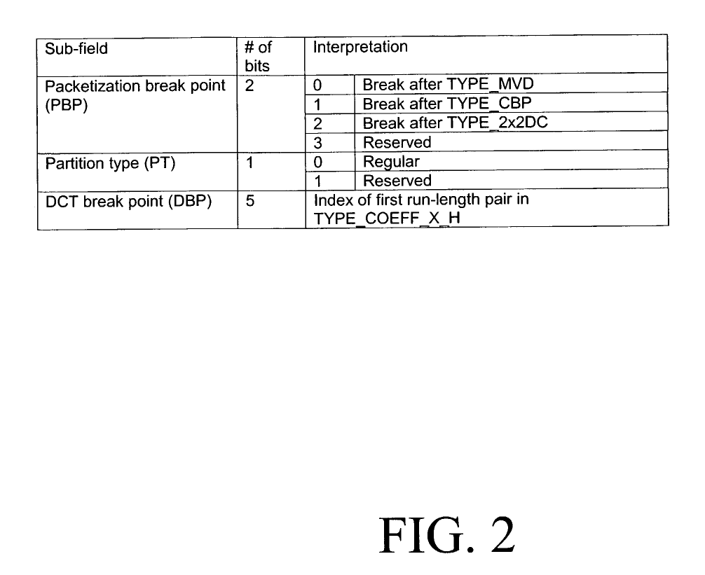

In addition, a new field, the packetization boundary indication (PBI), has been added to the end of TYPE_HEADER. An exemplary field structure for the PBI is shown in FIG. 2. As shown, the PBI field is further divided into three sub-fields. The first sub-field is packetization break point (PBP) (2 bits), which indicates which partition packetization should break. Namely, by changing the PBI, the user can select which packet should include TYPE_CBP and TYPE_{—}2×2DC. The second sub-field is partition type (PT) (1 bit), which is set to 0, with 1 being reserved. The third sub-field is DCT break point (DBP) (5 bits), which indicates the beginning of the index of the first DCT run-length VLC pair in TYPE_COEFF_X_H (where X is either Y or C). Thus, PBI, which is pre-selected, identifies the boundary between high and low frequency DCT coefficients TYPE_COEFF_X_L and TYPE-COEFF_X_H. Obviously, other PBI structures than that depicted in FIG. 2 could be implemented to achieve the same functionality, and such other structures fall within the scope of this invention.

As noted above, the NAL packetization process creates two packets, wherein each packet includes several different types of partitioned data. In accordance with the present invention, a packetization scheme is selected based on which mode is implemented by the VCL 12. Thus, for example, partition Mode One results in packetization Scheme One being implemented, while partition Mode Two results in packetization Scheme Two being implemented. NAL 16 can determine which scheme to use based on whether the TYPE_HEADER partition ends with a PBI field or not.

If no PBI field is included, packetization Scheme One is utilized, which reflects the scheme utilized in the current H.26L specification. As expected, all header and motion vector information are contained in Packet One, all intra coded block pattern and DCT data information are contained in Packet Two, and all inter coded block pattern (CBP) and DCT information are contained in Packet Three.

If however the TYPE_HEADER partition ends with the PBI field, packetization operates under Scheme Two. In this case, the contents of the resulting packets will depend on the values in the PBI field. The following is an example with a PBP value of 2, and a PT value of 0.

Packet One

TYPE_HEADER (with PBI field)

TYPE_MBHEADER

TYPE_MVD

TYPE_CBP

TYPE_{—}2×2DC

TYPE_COEFF_Y_L

TYPE_COEFF_C_L

Packet Two

TYPE_COEFF_Y_H

TYPE_COEFF_C_H

TYPE_EOS

In this Scheme Two example, the low frequency DCT coefficients are packetized in Packet One, while the high frequency DCT coefficients are packetized in Packet Two. Accordingly, flexible packetization is achieved. As is evident, changing the PBP value in the PBI field will alter the contents of the packets under Scheme Two. Accordingly, it should be appreciated that different variations can be achieved under Scheme Two.

Also shown in FIG. 1 is H.26L decoding system 18, which includes a depacketizing system 20 and a decoder 22. Prior to decoding, the packets are depacketized into the 8 (Packetization Scheme One) or 10 (Packetization Scheme Two) partitions for decoding. The decoder 22 fetches data from the right partition depending on which scheme is implemented.

It is understood that the systems, functions, mechanisms, methods, algorithms and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. An H.26L coding system, comprising:
a video coding layer (VCL) having a first partition mode and a second partition mode for partitioning video data, wherein the second partition mode separately partitions low and high frequency DCT coefficients; and
a network adaptation layer (NAL) for packetizing data into a first and second packet, wherein the first packet is configured to contain low frequency DCT coefficients and the second packet is configured to contain high frequency DCT coefficients when the second partition mode is implemented by the VCL.

2. The H.26L coding system of claim 1, wherein the first partition mode comprises a first partition that contains header symbols of coded macroblocks; a second partition that contains coded block patterns and DCT data for intra blocks; and a third partition that contains coded block patterns and DCT data for inter blocks.

3. The H.26L coding system of claim 2, wherein the second partition mode includes TYPE_HEADER, TYPE_MBHEADER, TYPE_MVD, TYPE_CBP, TYPE_{—}2×2DC, TYPE_EOS and divides each of TYPE_COEFF_Y and TYPE_COEFF_C into a high frequency type and a low frequency type.

4. The H.26L coding system of claim 2, wherein the second partition mode includes TYPE_HEADER, TYPE_MBHEADER, TYPE_MVD, TYPE_CBP, TYPE_{—}2×2DC, TYPE_EOS, TYPE_COEFF_Y_L, TYPE_COEFF_C_L, TYPE_COEFF_Y _H, and TYPE_COEFF_C_H.

5. The H.26L coding system of claim 4, wherein the NAL packetizes TYPE_HEADER, TYPE_MBHEADER, and TYPE_MVD into the first packet and packetizes TYPE_CBP, TYPE_{—}2×2DC, TYPE_COEFF_Y, TYPE_COEFF_C, and TYPE_EOS into the second packet when the first partition mode is used.

6. The H.26L coding system of claim 4, wherein the NAL packetizes TYPE_COEFF_Y_L and TYPE_COEFF_C_L into the first packet and TYPE_COEFF_Y_H, and TYPE_COEFF_C_H into the second packet when the second partition mode is used.

7. The H.26L coding system of claim 4, wherein TYPE_HEADER includes a field having a packetization boundary indication that determines a break point between high and low frequency DCT coefficients and signals the NAL to partition the high and low frequency DCT coefficients.

8. The H.26L coding system of claim 7, wherein the packetization boundary indication further determines which packet should include TYPE_CBP, TYPE_{—}2×2DC.

9. A method of partitioning and packetizing video data in an H.26L environment, comprising:
packetizing header data into a first packet, coded block pattern and DCT data for intra blocks into a second packet, and coded block pattern and DCT data for inter blocks into a third packet when a first partition mode is selected; and
packetizing header data and low frequency DCT coefficients into a first packet and high frequency DCT coefficients into a second packet when a second partition mode is selected.

10. The method of claim 9, further comprising:
providing a video coding layer (VCL) for partitioning video data;
packetizing TYPE_HEADER, TYPE_MBHEADER, and TYPE_MVD into the first packet and packetizing TYPE_CBP, TYPE_{—}2×2DC, TYPE_COEFF_Y, TYPE_COEFF_C, and TYPE_EOS into the second packet when the first mode is used; and
packetizing TYPE_COEFF_Y_L and TYPE_COEFF_C_L into the first packet and TYPE_COEFF_Y_H, and TYPE_COEFF_C₁₃ H into the second packet when the second mode is used.

11. The method of claim 10, comprising the further steps of:
setting a breakpoint between high and low frequency DCT coefficients; and
storing the breakpoint in a boundary indication field in TYPE_HEADER.

12. The method of claim 11, wherein TYPE_COEFF_Y_L and TYPE_COEFF_C_L are packetized into the first packet and TYPE_COEFF_Y_H, and TYPE_COEFF_C_H are packetized into the second packet when the boundary indication field is included in TYPE_HEADER.

13. The method of claim 11, wherein the boundary indication field further determines which packet should include TYPE_CBP and TYPE_{—}2×2DC.

14. A program product stored on a recordable medium for packetizing and partitioning video data in an H.26L environment, comprising:
means for packetizing header data into a first packet, coded block pattern and DCT data for intra blocks into a second packet, and coded block pattern and DCT data for inter blocks into a third packet when a first partition mode is selected; and
means for packetizing header data and low frequency DCT coefficients into a first packet and high frequency DCT coefficients into a second packet when a second partition mode is selected.

15. The program product of claim 14, further comprising:
means for packetizing TYPE_HEADER, TYPE_MBHEADER, and TYPE_MVD into the first packet and packetizing TYPE_CBP, TYPE_{—}2×2DC, TYPE_COEFF_Y, TYPE_COEFF_C, and TYPE_EOS into the second packet when the first partition mode is used; and
means for packetizing TYPE_COEFF_Y_L and TYPE_COEFF_C_L into the first packet and TYPE_COEFF_Y_H, and TYPE_COEFF_C_H into the second packet when the second partition mode is used.

16. The program product of claim 15, comprising the further steps of:
means for setting a breakpoint between high and low frequency DCT coefficients; and
means for storing the breakpoint in a boundary indication field in TYPE_HEADER.

17. The program product of claim 16, wherein TYPE_COEFF_Y_L and TYPE_COEFF_C_L are packetized into the first packet and TYPE COEFF_Y_H, and TYPE_COEFF_C_H are packetized into the second packet when the boundary indication field is included in TYPE_HEADER.

18. The program product of claim 16, wherein the boundary indication field further determines which packet should include TYPE_CBP and TYPE_{—}2×2DC.

19. A decoding system for decoding video data in an H.26L environment, wherein the video data was packetized in one of two schemes, including:
a first scheme, wherein header data are packetized into a first packet type, coded block pattern and DCT data for intra blocks are packetized into a second packet type, and coded block pattern and DCT data for inter blocks are packetized into a third packet type; a second scheme, wherein header data and low frequency DCT coefficients are packetized into the first packet type and high frequency DCT coefficients are packetized into the second packet type; and
wherein the decoding system includes:
a depacketizer system for determining which of the first and second scheme was used and for depacketizing video data from the packets; and
a decoder for decoding the video data.
